(19) United States
(12) Patent Application Publication
(10) Pub. No.: US 2023/0063830 A1
(43) Pub. Date: Mar. 2, 2023

(54) SYSTEM AND METHOD FOR MACHINE LEARNING ARCHITECTURE WITH MULTIPLE POLICY HEADS

(71) Applicant: ROYAL BANK OF CANADA, Toronto (CA)

(72) Inventors: Xiao Qi SHI, Toronto (CA); Hasham BURHANI, Peterborough (CA); Daniel BALICKI, Toronto (CA)

(21) Appl. No.: 17/893,288

(22) Filed: Aug. 23, 2022

Related U.S. Application Data
(60) Provisional application No. 63/236,424, filed on Aug. 24, 2021.

(51) Int. Cl. G06K 9/62; G06N 3/08; G06N 3/063

(52) U.S. Cl. CPC G06K 9/6262; G06N 3/08; G06N 3/063; G06Q 40/04

(57) ABSTRACT

Systems, devices, and methods for automated generation of resource task requests are disclosed. A reinforcement learning neural network having an output layer with a plurality of policy heads is maintained. At least one reward is provided to the reinforcement learning neural network, the at least one reward corresponding to at least one prior resource task request generated based on outputs of the reinforcement learning neural network. State data are provided to the reinforcement learning neural network, the state data reflective of a current state of an environment in which resource task requests are made. A plurality of outputs is obtained, each from a corresponding policy head, the plurality of outputs including a first output defining a quantity of a resource and a second output defining a cost of the resource. A resource task request signal is generated based on the plurality of outputs from the plurality of policy heads.

### CROSS-REFERENCE TO RELATED APPLICATION

This application claims the benefit of and priority to U.S. patent application No. 63/236,424 filed on Aug. 24, 2021, the entire content of which is herein incorporated by reference.

### FIELD

The present disclosure generally relates to the field of computer processing and reinforcement learning.

### BACKGROUND

A reward system is an aspect of a reinforcement learning neural network, indicating what constitutes good and bad results within an environment. Reinforcement learning processes can require a large amount of data. Learning by reinforcement learning processes can be slow.

### SUMMARY

In an aspect, there is provided a computer-implemented system for automated generation of resource task requests. The system includes a communication interface; at least one processor; and memory in communication with the at least one processor. Software code stored in the memory, when executed at the at least one processor causes the system to: maintain a reinforcement learning neural network having an output layer with a plurality of policy heads; provide, to the reinforcement learning neural network, at least one reward corresponding to at least one prior resource task request generated based on outputs of the reinforcement learning neural network; provide, to the reinforcement learning neural network, state data reflective of a current state of an environment in which resource task requests are made; obtain a plurality of outputs, each from a corresponding policy head of the plurality of policy heads, the plurality of outputs including a first output defining a quantity of a resource and a second output defining a cost of the resource; and generate a resource task request signal based on the plurality of outputs from the plurality of policy heads.

In the system, the providing the at least one reward may include providing the at least one reward to each of the plurality of policy heads.

In the system, the at least one reward may include a plurality of rewards, each associated with a corresponding sub-goal of the resource task requests.

In the system, the providing the at least one reward may include providing to each of the plurality of policy heads a subset of the plurality of rewards selected for that policy head.

In the system, the reinforcement learning neural network may be maintained in an automated agent.

In the system, the plurality of outputs may include at least one output defining an action to be taken by the automated agent.

In the system, the plurality of outputs may include at least one output defining a parameter of the action.

In the system, the generating may include combining at least two of the plurality of outputs.

In the system, the output layer may be interconnected with a plurality of hidden layers of the reinforcement learning neural network.

In the system, the resource task request signal may encode a request to trade a security.

In the system, the plurality of outputs may include at least one output indicating whether the request to trade a security should be made in a lit pool or a dark pool.

In the system, the environment may include a trading venue.

In another aspect, there is provided a computer-implemented method for automatically generating resource task requests. The method includes: maintaining a reinforcement learning neural network having an output layer with a plurality of policy heads; providing, to the reinforcement learning neural network, at least one reward corresponding to at least one prior resource task request generated based on outputs of the reinforcement learning neural network; providing, to the reinforcement learning neural network, state data reflective of a current state of an environment in which resource task requests are made; obtaining a plurality of outputs, each from a corresponding policy head of the plurality of policy heads, the plurality of outputs including a first output defining a quantity of a resource and a second output defining a cost of the resource; and generating a resource task request signal based on the plurality of outputs from the plurality of policy heads.

In the method, the providing the at least one reward may include providing the at least one reward to each of the plurality of policy heads.

In the method, the at least one reward may include a plurality of rewards, each associated with a corresponding sub-goal of the resource task requests.

In the method, the providing the at least one reward may include providing to each of the plurality of policy head a subset of the plurality of rewards selected for that policy head.

In another aspect, there is provided a non-transitory computer-readable storage medium storing instructions which when executed adapt at least one computing device to: maintain a reinforcement learning neural network having an output layer with a plurality of policy heads; provide at least one reward to the reinforcement learning neural network, the reward corresponding to prior resource task request generated based on the output of the reinforcement learning neural network; provide state data reflective of a current state of an environment in which resource task requests are made to the reinforcement learning neural network; obtain a plurality of outputs, each from a corresponding policy head of the plurality of policy heads, the plurality of outputs including a first output defining a quantity of a resource and a second output defining a cost of the resource; and generate a resource task request signal based on the plurality of outputs from the plurality of policy heads.

Before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### BRIEF DESCRIPTION OF THE FIGURES

In the Figures, which illustrate example embodiments,

FIG. 1A is a schematic diagram of a computer-implemented system for providing an automated agent, in accordance with an embodiment;

FIG. 1B is a schematic diagram of an automated agent, in accordance with an embodiment;

FIG. 1C is a schematic diagram of an example neural network maintained at the computer-implemented system of FIG. 1A, in accordance with an embodiment;

FIG. 2A is an example screen from a lunar lander game, in accordance with an embodiment;

FIGS. 2B and 2C each shows a screen shot of a chatbot implemented using an automated agent, in accordance with an embodiment;

FIG. 3 is a schematic diagram of an example reinforcement learning network with multiple policy heads, in accordance with an embodiment;

FIG. 4A is a schematic diagram of rewards being provided to the policy heads of FIG. 3, in accordance with an embodiment;

FIG. 4B is a schematic diagram of rewards being provided to the policy heads of FIG. 3, in accordance with an embodiment;

FIG. 5 is a flowchart showing example operation of the system of FIG. 1A, in accordance with an embodiment;

FIG. 6 is a graph showing probability of an automated agent landing on a particular action; and

FIG. 7 is a schematic diagram of a system having a plurality of automated agents, in accordance with an embodiment.

### DETAILED DESCRIPTION

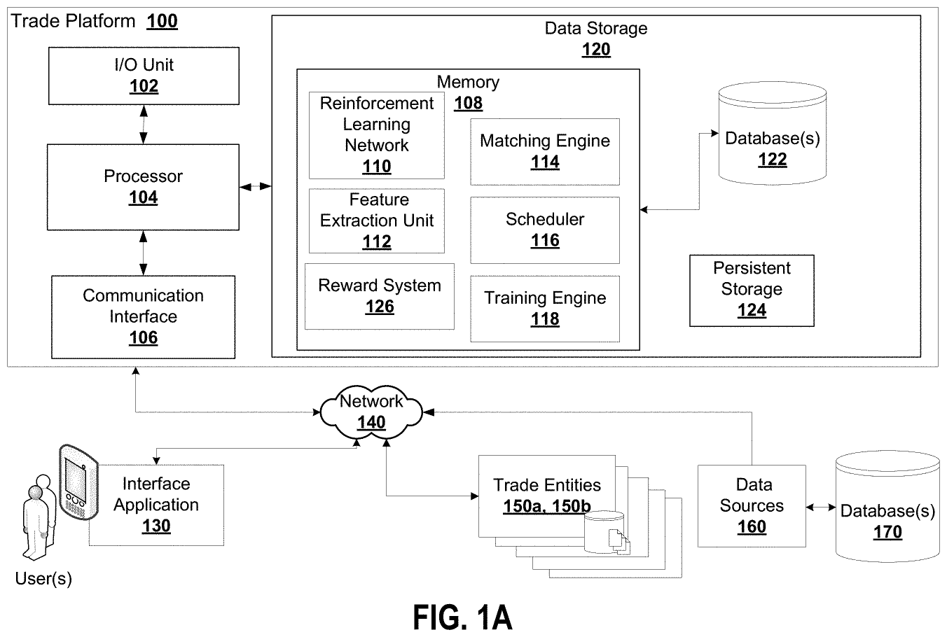

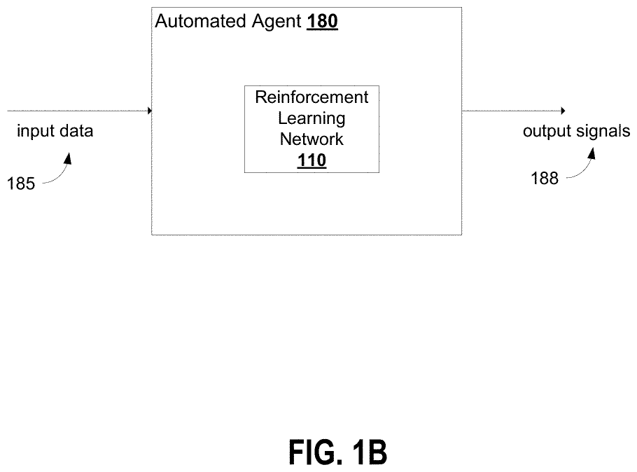

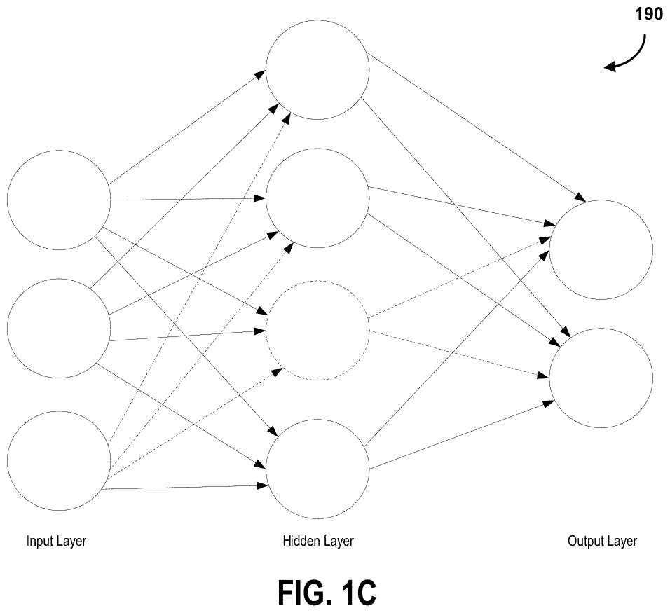

FIG. 1A is a high-level schematic diagram of a computer-implemented system 100 for providing an automated agent having a neural network, in accordance with an embodiment. The automated agent is instantiated and trained by system 100 in manners disclosed herein to generate task requests.

As detailed herein, in some embodiments, system 100 includes features adapting it to perform certain specialized purposes. For example, in various embodiments, system 100 includes features adapting it for automatic control of a heating, ventilation, and air conditioning (HVAC) system, a traffic control system, a vehicle control system, or the like.

In some embodiments, system 100 includes features adapting it to function as a trading platform. In such embodiments, system 100 may be referred to as trading platform 100 or simply as platform 100 for convenience. In such embodiments, the automated agent may generate requests for tasks to be performed in relation to securities (e.g., stocks, bonds, options or other negotiable financial instruments). For example, the automated agent may generate requests to trade (e.g., buy and/or sell) securities by way of a trading venue.

Referring now to the embodiment depicted in FIG. 1A, trading platform 100 has data storage 120 storing a model for a reinforcement learning neural network. The model is used by trading platform 100 to instantiate one or more automated agents 180 (FIG. 1B) that each maintain a reinforcement learning neural network 110 (which may be referred to as a reinforcement learning network 110 or network 110 for convenience).

A processor 104 is configured to execute machine-executable instructions to train a reinforcement learning network 110 based on a reward system 126. The reward system generates good (or positive) signals and bad (or negative) signals to train automated agents 180 to perform desired tasks more optimally, e.g., to minimize and maximize certain performance metrics. In some embodiments, an automated agent 180 may be trained by way of signals generated in accordance with reward system 126 to minimize Volume Weighted Average Price (VWAP) slippage. For example, reward system 126 may implement rewards and punishments substantially as described in U.S. patent application Ser. No. 16/426,196, entitled “Trade platform with reinforcement learning”, filed May 30, 2019, the entire contents of which are hereby incorporated by reference herein.

In some embodiments, trading platform 100 can generate reward data by normalizing the differences of the plurality of data values (e.g. VWAP slippage), using a mean and a standard deviation of the distribution.

Throughout this disclosure, it is to be understood that the terms “average” and “mean” refer to an arithmetic mean, which can be obtained by dividing a sum of a collection of numbers by the total count of numbers in the collection.

In some embodiments, trading platform 100 can normalize input data for training the reinforcement learning network 110. The input normalization process can involve a feature extraction unit 112 processing input data to generate different features such as pricing features, volume features, time features, Volume Weighted Average Price features, market spread features. The pricing features can be price comparison features, passive price features, gap features, and aggressive price features. The market spread features can be spread averages computed over different time frames. The Volume Weighted Average Price features can be current Volume Weighted Average Price features and quoted Volume Weighted Average Price features. The volume features can be a total volume of an order, a ratio of volume remaining for order execution, and schedule satisfaction. The time features can be current time of market, a ratio of time remaining for order execution, and a ratio of order duration and trading period length.

The input normalization process can involve computing upper bounds, lower bounds, and a bounds satisfaction ratio; and training the reinforcement learning network using the upper bounds, the lower bounds, and the bounds satisfaction ratio. The input normalization process can involve computing a normalized order count, a normalized market quote and/or a normalized market trade. The platform 100 can have a scheduler 116 configured to follow a historical Volume Weighted Average Price curve to control the reinforcement learning network 110 within schedule satisfaction bounds computed using order volume and order duration.

The platform 100 can connect to an interface application 130 installed on user device to receive input data. Trade entities 150a, 150b can interact with the platform to receive output data and provide input data. The trade entities 150a, 150b can have at least one computing device. The platform 100 can train one or more reinforcement learning neural networks 110. The trained reinforcement learning networks 110 can be used by platform 100 or can be for transmission to trade entities 150a, 150b, in some embodiments. The platform 100 can process trade orders using the reinforcement learning network 110 in response to commands from trade entities 150a, 150b, in some embodiments.

The platform 100 can connect to different data sources 160 and databases 170 to receive input data and receive output data for storage. The input data can represent trade orders. Network 140 (or multiple networks) is capable of carrying data and can involve wired connections, wireless connections, or a combination thereof. Network 140 may involve different network communication technologies, standards and protocols, for example.

The platform 100 can include an I/O unit 102, a processor 104, communication interface 106, and data storage 120. The I/O unit 102 can enable the platform 100 to interconnect with one or more input devices, such as a keyboard, mouse, camera, touch screen and a microphone, and/or with one or more output devices such as a display screen and a speaker.

The processor 104 can execute instructions in memory 108 to implement aspects of processes described herein. The processor 104 can execute instructions in memory 108 to configure a data collection unit, interface unit (to provide control commands to interface application 130), reinforcement learning network 110, feature extraction unit 112, matching engine 114, scheduler 116, training engine 118, reward system 126, and other functions described herein. The processor 104 can be, for example, any type of general-purpose microprocessor or microcontroller, a digital signal processing (DSP) processor, an integrated circuit, a field programmable gate array (FPGA), a reconfigurable processor, or any combination thereof.

As depicted in FIG. 1B, automated agent 180 receives input data (via a data collection unit) and generates output signal according to its reinforcement learning network 110 for provision to trade entities 150a, 150b. Reinforcement learning network 110 can refer to a neural network that implements reinforcement learning.

FIG. 1C is a schematic diagram of an example neural network 190, in accordance with an embodiment. The example neural network 190 can include an input layer, one or more hidden layers, and an output layer. The neural network 190 processes input data using its layers based on reinforcement learning, for example. The neural network 190 is an example neural network for the reinforcement learning network 110 of the automated agent 180.

Reinforcement learning is a category of machine learning that configures agents, such the automated agents 180 described herein, to take actions in an environment to maximize a notion of a reward. The processor 104 is configured with machine executable instructions to instantiate an automated agent 180 that maintains a reinforcement learning neural network 110 (also referred to as a reinforcement learning network 110 for convenience), and to train the reinforcement learning network 110 of the automated agent 180 using a training unit 118. The processor 104 is configured to use the reward system 126 in relation to the reinforcement learning network 110 actions to generate good signals and bad signals for feedback to the reinforcement learning network 110. In some embodiments, the reward system 126 generates good signals and bad signals to minimize Volume Weighted Average Price slippage, for example. Reward system 126 is configured to receive control the reinforcement learning network 110 to process input data in order to generate output signals. Input data may include trade orders, various feedback data (e.g., rewards), or feature selection data, or data reflective of completed tasks (e.g., executed trades), data reflective of trading schedules, etc. Output signals may include signals for communicating resource task requests, e.g., a request to trade in a certain security. For convenience, a good signal may be referred to as a “positive reward” or simply as a reward, and a bad signal may be referred as a “negative reward” or as a punishment.

Referring again to FIG. 1A, feature extraction unit 112 is configured to process input data to compute a variety of features. The input data can represent a trade order. Example features include pricing features, volume features, time features, Volume Weighted Average Price features, market spread features. These features may be processed to compute state data, which can be a state vector. The state data may be used as input to train an automated agent 180.

Matching engine 114 is configured to implement a training exchange defined by liquidity, counter parties, market makers and exchange rules. The matching engine 114 can be a highly performant stock market simulation environment designed to provide rich datasets and ever changing experiences to reinforcement learning networks 110 (e.g. of agents 180) in order to accelerate and improve their learning. The processor 104 may be configured to provide a liquidity filter to process the received input data for provision to the machine engine 114, for example. In some embodiments, matching engine 114 may be implemented in manners substantially as described in U.S. patent application Ser. No. 16/423,082, entitled “Trade platform with reinforcement learning network and matching engine”, filed May 27, 2019, the entire contents of which are hereby incorporated herein.

Scheduler 116 is configured to follow a historical Volume Weighted Average Price curve to control the reinforcement learning network 110 within schedule satisfaction bounds computed using order volume and order duration.

The interface unit 130 interacts with the trading platform 100 to exchange data (including control commands) and generates visual elements for display at user device. The visual elements can represent reinforcement learning networks 110 and output generated by reinforcement learning networks 110.

Memory 108 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Data storage devices 120 can include memory 108, databases 122, and persistent storage 124.

The communication interface 106 can enable the platform 100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The platform 100 can be operable to register and authenticate users (using a login, unique identifier, and password for example) prior to providing access to applications, a local network, network resources, other networks and network security devices. The platform 100 may serve multiple users which may operate trade entities 150a, 150b.

The data storage 120 may be configured to store information associated with or created by the components in memory 108 and may also include machine executable instructions. The data storage 120 includes a persistent storage 124 which may involve various types of storage technologies, such as solid state drives, hard disk drives, flash memory, and may be stored in various formats, such as relational databases, non-relational databases, flat files, spreadsheets, extended markup files, etc.

A reward system 126 integrates with the reinforcement learning network 110, dictating what constitutes good and bad results within the environment. In some embodiments, the reward system 126 is primarily based around a common metric in trade execution called the Volume Weighted Average Price (“VWAP”). The reward system 126 can implement a process in which VWAP is normalized and converted into the reward that is fed into models of reinforcement learning networks 110. The reinforcement learning network 110 processes one large order at a time, denoted a parent order (i.e. Buy 10000 shares of RY.TO), and places orders on the live market in small child slices (i.e. Buy 100 shares of RY.TO @ 110.00). A reward can be calculated on the parent order level (i.e. no metrics are shared across multiple parent orders that the reinforcement learning network 110 may be processing concurrently) in some embodiments.

To achieve proper learning, the reinforcement learning network 110 is configured with the ability to automatically learn based on good and bad signals. To teach the reinforcement learning network 110 how to minimize VWAP slippage, the reward system 126 provides good and bad signals to minimize VWAP slippage.

The reward system 126 can normalize the reward for provision to the reinforcement learning network 110. The processor 104 is configured to use the reward system 126 to process input data to generate Volume Weighted Average Price data. The input data can represent a parent trade order. The reward system 126 can compute reward data using the Volume Weighted Average Price and compute output data by processing the reward data using the reinforcement learning network 110. In some embodiments, reward normalization may involve transmitting trade instructions for a plurality of child trade order slices based on the generated output data.

### Other Practical Applications

As shown in FIG. 1B, automated agent 180 receives input data 185 (e.g., from one or more data sources 160 or via a data collection unit) and generates output signal 188 according to its reinforcement learning network 110. In some embodiments, the output signal 188 can be transmitted to another system, such as a control system, for executing one or more commands represented by the output signal 188.

In some embodiments, once the reinforcement learning network 110 has been trained, it generates output signal 188 reflective of its decisions to take particular actions in response to input data 185. Input data 185 can include, for example, a set of data obtained from one or more data sources 160, which may be stored in databases 170 in real time or near real time.

As a practical example, an HVAC control system which may be configured to set and control heating, ventilation, and air conditioning (HVAC) units for a building, in order to efficiently manage the power consumption of HVAC units, the control system may receive sensor data representative of temperature data in a historical period. In this example, components of the HVAC system including various elements of heating, cooling, fans, or the like may be considered resources subject of a resource task request 188. The control system may be implemented to use an automated agent 180 and a trained reinforcement learning network 110 to generate an output signal 188, which may be a resource request command signal 188 indicative of a set value or set point representing a most optimal room temperature based on the sensor data, which may be part of input data 185, representative of the temperature data in present and in a historical period (e.g., the past 72 hours or the past week).

The input data 185 may include a time series data that is gathered from sensors 160 placed at various points of the building. The measurements from the sensors 160, which form the time series data, may be discrete in nature. For example, the time series data may include a first data value 21.5 degrees representing the detected room temperature in Celsius at time t₁, a second data value 23.3 degrees representing the detected room temperature in Celsius at time t₂, a third data value 23.6 degrees representing the detected room temperature in Celsius at time t₃, and so on.

Other input data 185 may include a target range of temperature values for the particular room or space and/or a target room temperature or a target energy consumption per hour. A reward may be generated based on the target room temperature range or value, and/or the target energy consumption per hour.

In some examples, one or more automated agents 180 may be implemented, each agent 180 for controlling the room temperature for a separate room or space within the building which the HVAC control system is monitoring.

As another example, in some embodiments, a traffic control system which may be configured to set and control traffic flow at an intersection. The traffic control system may receive sensor data representative of detected traffic flows at various points of time in a historical period. The traffic control system may use an automated agent 180 and trained reinforcement learning network 110 to control a traffic light based on input data representative of the traffic flow data in real time, and/or traffic data in the historical period (e.g., the past 4 or 24 hours). In this example, components of the traffic control system including various signaling elements such as lights, speakers, buzzers, or the like may be considered resources subject of a resource task request 188.

The input data 185 may include sensor data gathered from one or more data sources 160 (e.g. sensors 160) placed at one or more points close to the traffic intersection. For example, the time series data 112 may include a first data value 3 vehicles representing the detected number of cars at time t₁, a second data value 1 vehicles representing the detected number of cars at time t₂, a third data value 5 vehicles representing the detected number of cars at time t₃, and so on.

Based on a desired traffic flow value at tₙ, the automated agent 180, based on neural network 110, may then generate an output signal 188 to shorten or lengthen a red or green light signal at the intersection, in order to ensure the intersection is least likely to be congested during one or more points in time.

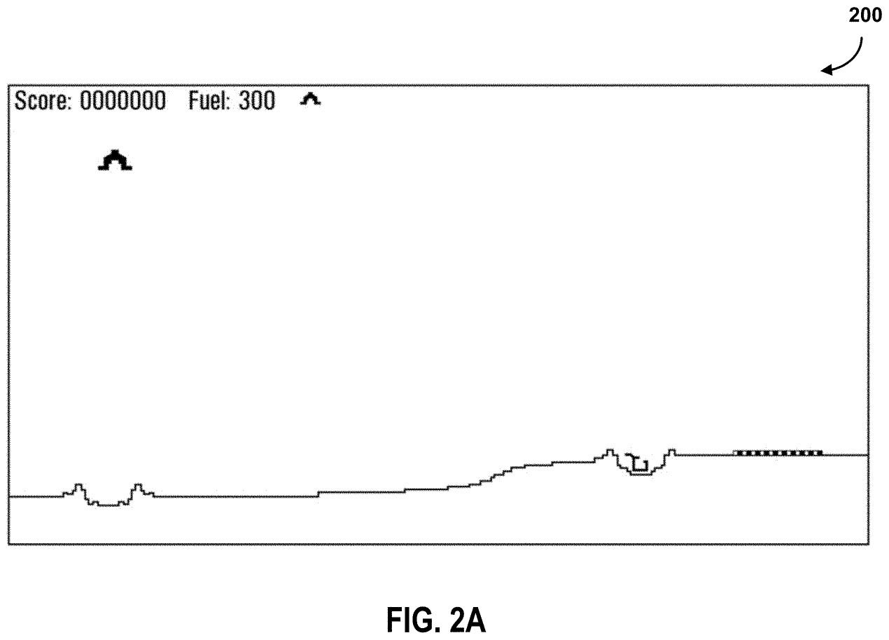

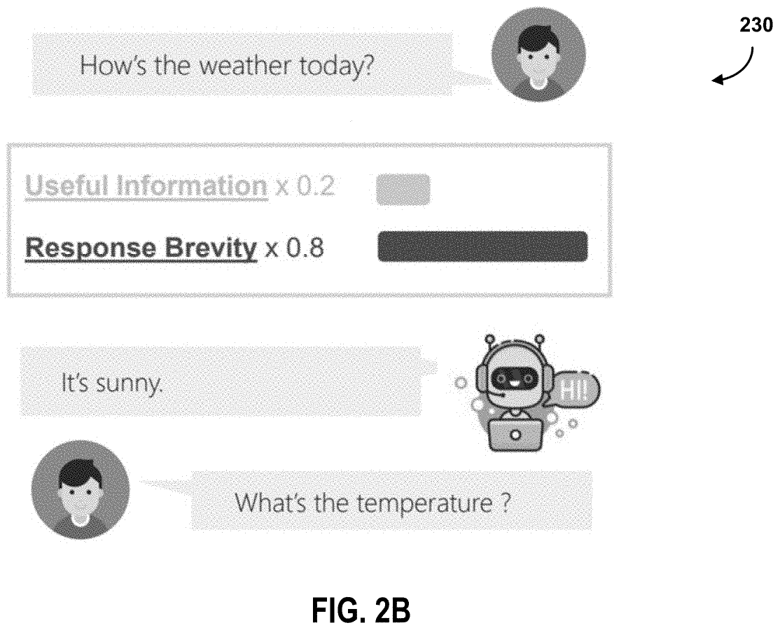

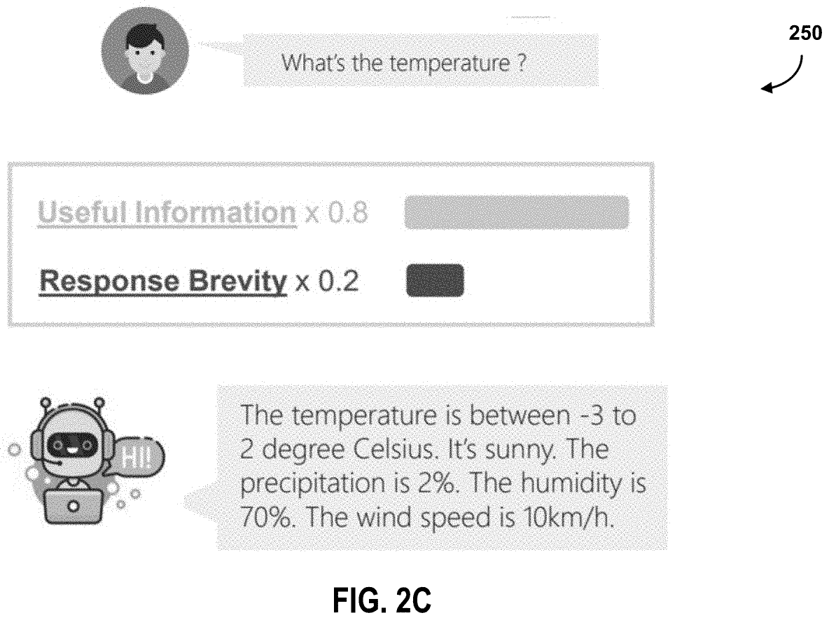

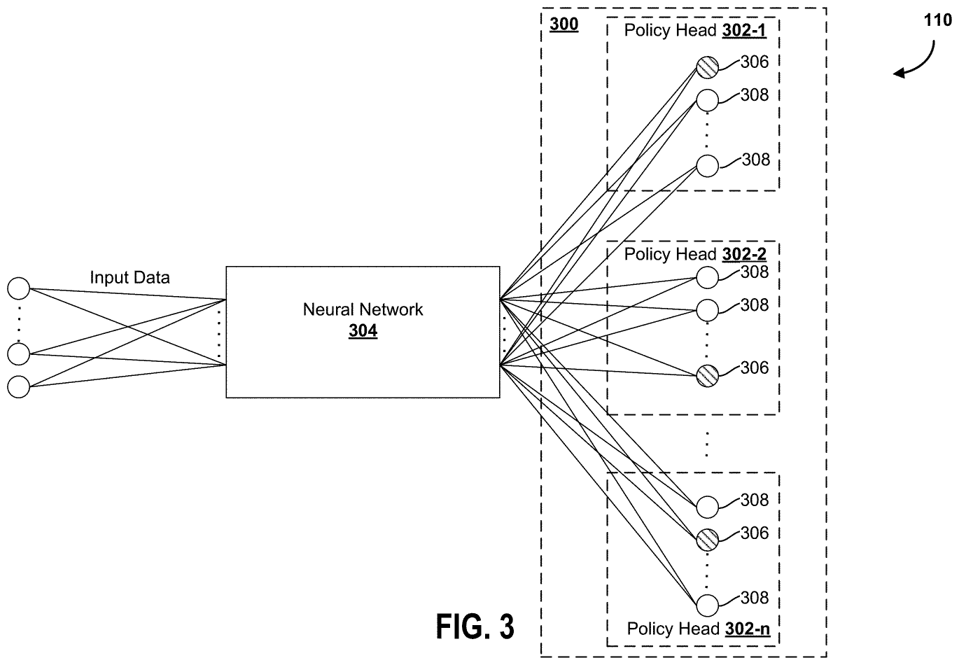

In some embodiments, as another example, an automated agent 180 in system 100 may be trained to play a video game, and more specifically, a lunar lander game 200, as shown in FIG. 2A. In this game, the goal is to control the lander's two thrusters so that it quickly, but gently, settles on a target landing pad. In this example, input data 185 provided to an automated agent 180 may include, for example, X-position on the screen, Y-position on the screen, altitude (distance between the lander and the ground below it), vertical velocity, horizontal velocity, angle of the lander, whether lander is touching the ground (Boolean variable), etc. In this example, components of the lunar lander such as its thrusters may be considered resources subject of a resource task request 188 computed by the multi-policy architecture shown in FIG. 3.

In some embodiments, the reward may indicate a plurality of objectives including: smoothness of landing, conservation of fuel, time used to land, and distance to a target area on the landing pad. The reward, which may be a reward vector, can be used to train the neural network 110 for landing the lunar lander by the automated agent 180.

In various embodiments, system 100 is adapted to perform certain specialized purposes. In some embodiments, system 100 is adapted to instantiate and train automated agents 180 for playing a video game such as the lunar lander game. In some embodiments, system 100 is adapted to instantiate and train automated agents 180 for implementing a chatbot that can respond to simple inquiries based on multiple client objectives. In other embodiments, system 100 is adapted to instantiate and train automated agents 180 for performing image recognition tasks. As will be appreciated, system 100 is adaptable to instantiate and train automated agents 180 for a wide range of purposes and to complete a wide range of tasks.

The reinforcement learning neural network 110, 190 may be implemented to solve a practical problem where competing interests may exist in a resource task request, based on input data 185. For example, referring now to FIG. 2B, when a chatbot is required to respond to a first query 230 such as “How's the weather today?”, the chatbot may be implemented to first determine a list of competing interests or objectives based on input data 185. A first objective may be usefulness of information, a second objective may be response brevity. The chatbot may be implemented to, based on the query 230, determine that usefulness of information has a weight of 0.2 while response brevity has a weight of 0.8. Therefore, the chatbot may proceed to generate an action (a response) that favours response brevity over usefulness of information based on a ratio of 0.8 to 0.2. Such a response may be, for example. “It's sunny.” In this example, informational responses provided by a chatbot may be considered resources subject of a resource task request 188.

For another example, referring now to FIG. 2C, when the same chatbot is required to respond to a second query 250 such as “What's the temperature?”, the chatbot may be implemented to again determine a list of competing interests or objectives input data 185. For this task or query, the first objective may still be usefulness of information, a second objective may be response brevity. The chatbot may be implemented to, based on the query 250, determine that usefulness of information has a weight of 0.8 while response brevity has a weight of 0.2. Therefore, the chatbot may proceed to generate an action (a response) that favours usefulness of information over response brevity based on a ratio of 0.8 to 0.2. Such a response may be, for example. “The temperature is between −3 to 2 degrees Celsius. It's sunny. The precipitation is 2% . . . ”.

FIG. 3 is a schematic diagram of the reinforcement learning network 110, in accordance with an embodiment.

In the depicted embodiment, reinforcement learning network 110 includes a neural network 304 (having one or more hidden layers) interconnected with a further layer 300 that serves as an output layer. The further layer 300 includes a plurality of policy heads, namely, policy heads 302-1, 302-2, . . . and 302-n. The number of policy heads (n) may vary from embodiment to embodiment, e.g., depending on the nature of task requests to be made by an automated agent 180 or on implementation variations. For convenience, these policy heads may be referred to individually as a policy head 302 or collectively as policy heads 302.

Each policy head 302 may maintain and update a separate policy. Such policy may, for example, define a probability distribution across actions that can be taken at a given time step by an automated agent 180 given an environment state. Such a policy may, for example, allow a particular action to be chosen by an automated agent 180 given a particular environment state. Referring to FIG. 3, for each policy head 302, the action chosen in accordance with its policy is depicted as a node 308 at the output of the policy head 302. Meanwhile, each action that is not chosen is depicted as a node 306.

The architecture depicted in FIG. 3 may be referred to as a multi-policy architecture or a multi-head architecture.

Conveniently, this multi-headed configuration of reinforcement network 110 allows multiple outputs to be generated in the same forward pass.

In the depicted embodiment, an automated agent 180 generates a task request using the outputs of two or more policy heads 302. In one example, the output of one policy head 302 may define the type of task to be requested, and the output of another policy head 302 may define a parameter of the task request. In another example, a plurality of outputs of policy heads 302 may define a plurality of corresponding parameters of a task request. When the task request is a request in relation to a resource (e.g., to obtain a resource or divest a resource), such parameters may define, for example, a quantity of the resource, a cost of the resource (e.g., a price for selling or buying the resource), or a time when the task should be completed.

In one example, when the task request is a request to trade a given security, each policy head 302 may generate an output corresponding to a trade parameter such as, a price, a volume, a slice size, a wait time, to name just a few examples. In one example, the output of a particular policy head 302 may indicate whether the request to trade the given security is to be made in a lit pool or a dark pool.

In the depicted embodiment, each policy head 302 may be dedicated to a particular portion of a resource request, and be responsible for selecting from a set of actions related to that portion of the resource request. In some embodiments, the ability for a policy head 302 to chose an action independently from other policy heads 302 may increase flexibility for the automated agent 180 to adjust its actions and thereby adapt to its environment, e.g., to adjust its aggressiveness and develop a strategy for task requests.

Compared to a neural network with only a singe head, each policy head 302 may chose from a reduced set of actions. Conveniently, in some embodiments, the smaller number of possible actions for each head allows overall training to proceed faster. Consequently, computing resources may be conserved.

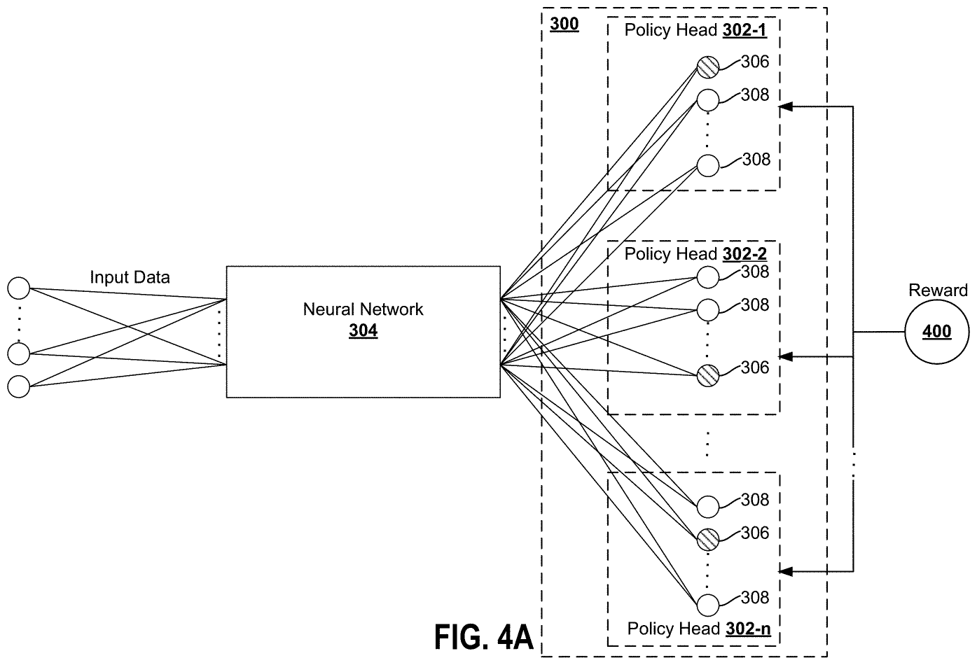

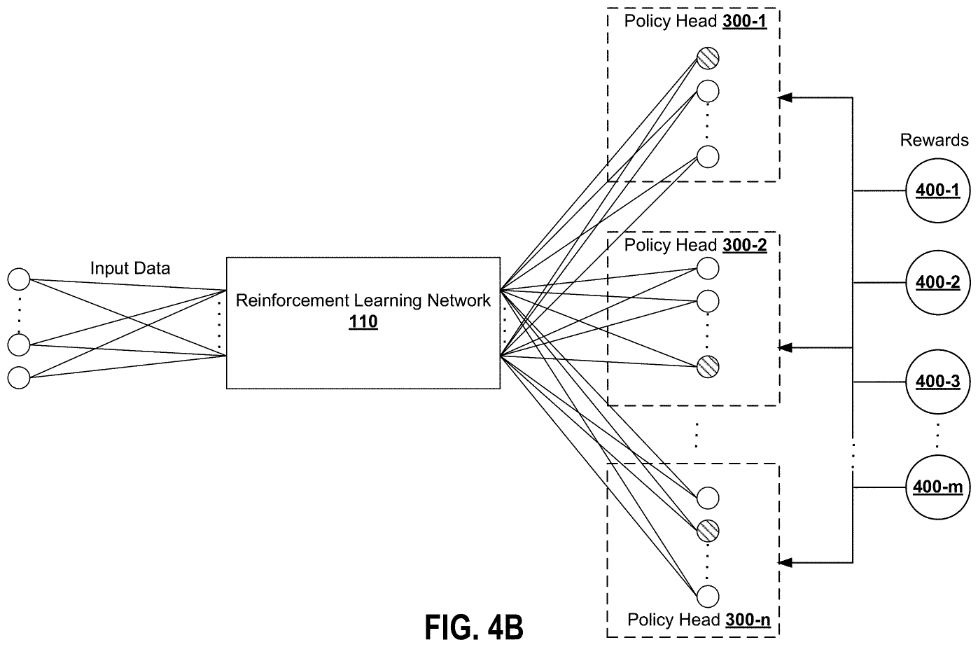

FIG. 4A is a schematic diagram of rewards being provided to the policy heads of FIG. 3, in accordance with an embodiment. As depicted, a reward 400 is provided separately to each policy head 302, for training each policy head 302. For example, the policy of each policy head 302 may be adjusted based on the reward 400 it receives. The reward 400 may correspond a positive reward or a negative reward, as generated by the reward system 126. In the depicted embodiment, at each time step, a reward 400 generated that is provided to each policy head 302.

FIG. 4B is a schematic diagram of rewards being provided to the policy heads of FIG. 3, in accordance with another embodiment. In this embodiment, a plurality of rewards, namely rewards 400-1, 400-2, 400-3 . . . 400-m, are generated. Each of the rewards may be defined in and generated by the reward system 126 in association with a particular sub-goal of a resource request. A particular sub-goal, may for example be related to any one of a desired quantity of a resource, a desired speed for completion of resource requests, increasing or decreasing the performance of particular task actions, or the like. When automated agent 180 is configured to trade securities, a particular sub-goal, may for example be related to any one of minimizing slippage, minimizing slippage in a window of time, minimizing market impact, increasing or decreasing the performance of particular trade actions (e.g., decreasing the number of far touch actions, or the number of cancel actions, or the like).

The number of rewards (m) may vary from embodiment to embodiment, e.g., depending on the number of sub-goals defined for the automated agent 180 or on implementation variations. For convenience, these rewards may be referred to individually as a reward 400 or collectively as rewards 400.

In the depicted embodiment, at each time step, a subset of rewards 400 is provided to each policy head 302. The particular subset of rewards 400 is selected in accordance with the sub-goal or sub-goals assigned to a particular policy head 302. A subset may include one or more of rewards 400. In one example, reward 400-1 is provided to policy head 302-1, reward 400-2 is provided to policy head 302-2, reward 400-3 is provided to policy head 302-3, and so on. However, the same reward 400 or combination of rewards 400 may also be provided to multiple policy heads 302 if they have a sub-goal or sub-goals in common. The particular subset of rewards 400 to be provided to each policy head 302 may be pre-defined within configuration parameters of the reward system 126.

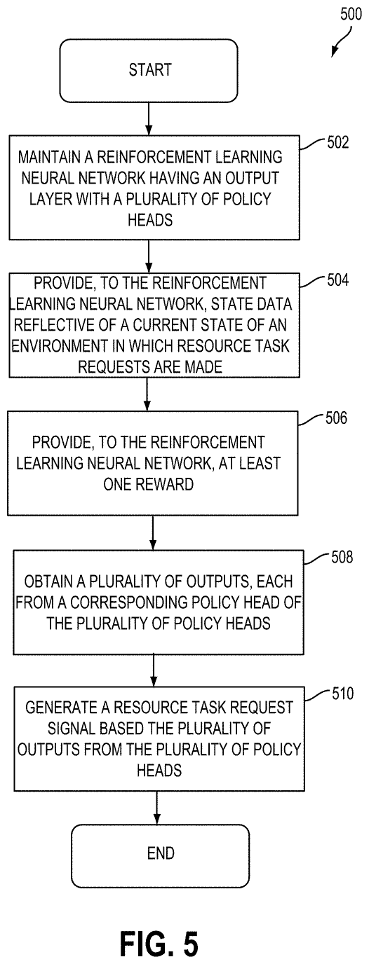

In some embodiments, the particular sub-goal or sub-goals assigned to a particular policy head 302 may change during operation, e.g., in response to detected environmental conditions. Accordingly, the particular subset of rewards 400 to be provided to each policy head 302 may change during operation in tandem with the sub-goal or sub-goals assigned the policy heads 302. The operation of the platform 100 is further described with reference to the flowchart depicted in FIG. 5. The platform 100 performs the example operations depicted at blocks 500 and onward, in accordance with an embodiment.

At block 502, the platform 100 maintains a reinforcement learning neural network 110 having an output layer with a plurality of policy heads 302. The reinforcement learning neural network 110 may be maintained in an automated agent 180 instantiated and operated at the platform 100.

At block 504, the platform 100 provides, to the reinforcement learning neural network 110, at least one reward 400 corresponding to at least one prior resource task request generated based on outputs of the reinforcement learning neural network 110. When there are multiple rewards 400, each reward 400 may be associated with a corresponding sub-goal associated with resource task requests. The rewards 400 may be generated at the reward system 126.

The at least one reward 400 (e.g., the same reward) may be provided to each of the plurality of policy heads 302. Alternatively, each of the policy heads 302 may be provided with a subset of the rewards 400, the particular subset selected for the particular policy head 302 based on the sub-goals assigned to that policy head 302.

At block 506, the platform 100 provides, to the reinforcement learning neural network 110, state data reflective of a current state of an environment in which resource task requests are made. In some embodiments, the environment may include one or more trading venues.

At block 508, the platform 100 obtains a plurality of outputs, each from a corresponding policy head 302, the plurality of outputs including, for example, a first output defining a quantity of a resource and a second output defining a cost of the resource. Various other outputs and combinations thereof are contemplated. In one example, an output of a policy head 302 defines an action to be taken by an automated agent 180. In another example, an output of a policy head 302 defines a parameter of an action.

At block 510, the platform 100 generates a resource task request signal based on the plurality of outputs from the plurality of policy heads 302. The resource task request signal encodes data defining a task request including various task parameters. In some embodiments, the resource task request signal encodes a request to trade a security. Generating the resource task request signal may include combining at least two of the plurality of outputs, e.g., combining a requested action with an associated action parameter.

It should be understood that steps of one or more of the blocks depicted in FIG. 5 may be performed in a different sequence or in an interleaved or iterative manner. Further, variations of the steps, omission or substitution of various steps, or additional steps may be considered.

The allocation of rewards 400 to particular policy heads 302 is further described with reference to an example embodiment. In this embodiment, automated agent 180 is trained to generate task requests relating to trading of securities. In this embodiment, automated agent 180 includes three policy heads 302, each responsible for selecting from a different set of actions (e.g., task request parameters). A first policy head 302-1 selects a set of actions relating to trade price such as, for example, (i) far touch—go to ask, (ii) near touch—place at bid, (iii) layer in—if there is an order at near touch, order about near touch, (iv) layer out—if there is an order at far touch, order close far touch, (v) skip—do nothing, and (vi) cancel—cancel most aggressive order. A second policy head 302-2 selects from a set of actions relating to wait time such as, for example, (i) quarter, (ii) half, (iii) normal, (iv) double, and (v) quadruple. A third policy head 302-3 selects from a set of actions relating to slice size such as, for example, (i) quarter, (ii) half, (iii) normal, (iv) double, and (v) quadruple. As will be appreciated, these sets of actions are examples only and may vary in other embodiments.

During operation, a plurality of rewards 400 are provided to automated agent. In this example, the plurality of rewards 400 may include a “cancel” reward defined in association with a sub-goal of avoiding cancel actions, such that a negative reward is provided to the automated agent 180 when it takes a cancel action. In this example, the plurality of rewards 400 may further include a “far touch” reward defined in association with a sub-goal of avoiding far touch actions, such that a negative reward is provided to the automated agent 180 when it takes a far touch action.

The two noted sub-goals are sub-goals of policy head 302-1, which is responsible for price actions such as a far touch action and a cancel action. In contrast, they are not sub-goals of policy head 302-2 and policy head 302-3 since they are unrelated to action selection for wait time or slice size. Accordingly, the “cancel” reward and the “far touch” reward are not provided to head 302-2 and policy head 302-3. In this example, this avoids potentially slowing down learning of automated agent 180 by providing a reward to policy heads that would be processed as noise that does not contribute to learning.

The application of a multi-head architecture as disclosed herein may provide certain technical advantages. For example, in some embodiments, the speed at which automated agent 180 updates its model (or learns) may be increased. This increase in speed can be understood with reference to the foregoing example embodiment with three policy heads 302-1, 302-2, and 303-3, respectively responsible price actions, wait time actions, and slice size actions.

In this example embodiment, the number of actions within the respective sets of actions of the policy heads 302 is 6 (set of actions relating to price), 5 (set of actions relating to wait time), and 5 (set of actions relating to slice size).

Consider now the specific scenario of updating the probability of a far touch action. In this example embodiment, for the model to update the probability of a far touch action, it only needs to modify probabilities within the set of actions relating to price (up to 6 actions). However, in a model without the multi-headed architecture, the total number of actions is 150 (6×5×5). Of these, 25 (1×5×5) actions are related to a far touch action. For this model without the multi-headed architecture, to update the probability of a far touch action, it would need to modify probabilities of 25 different actions. This requires automated agent 180 to land on (e.g., select) and update each of those 25 different actions (from amongst 150 possible actions). This is computationally expensive and/or impractical because most reinforcement learning update only one action at a time (e.g., at each time step).

Even in the best case (which has very low probability), it would take at least 25 time steps to update the probability of a far touch action. In contrast, in a model with the multi-headed architecture, in the best case (with probability ⅙), it would only take 1 time step to update the probability.

In some cases, the computational expense may be exponentially greater in the absence of a multi-headed architecture, e.g., as the total number of actions increases.

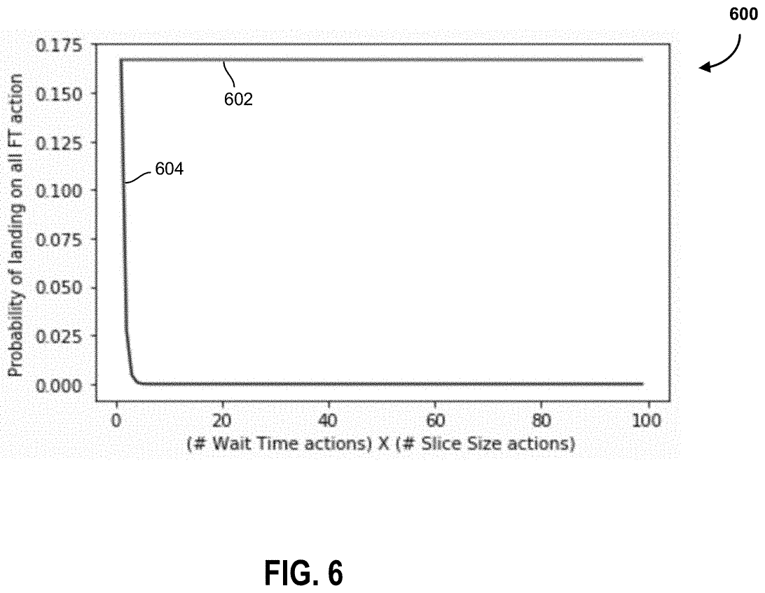

FIG. 6 shows a graph 600 of the probability of selecting a far touch related action during a time step, as a function of the number of actions relating to wait time or slice size.

In graph 600, line 602 represents the probability of selecting a far touch related action in a model with the multi-headed architecture. For line 602, the probability of a far touch action is assumed to be fixed in the set of actions relating to price. Landing on far touch related actions is a constant because there is only one far touch action head inside the action set relating to pricing.

In graph 600, line 604 represents the probability of selecting a far touch related action in a model without the multi-headed architecture. The probability of landing on far touch related actions depends on the number of actions in the action sets relating to wait time and slice size. As shown, the probability of landing on far touch related actions drops drastically as the number of actions in the action sets relating to wait time and slice size increases.

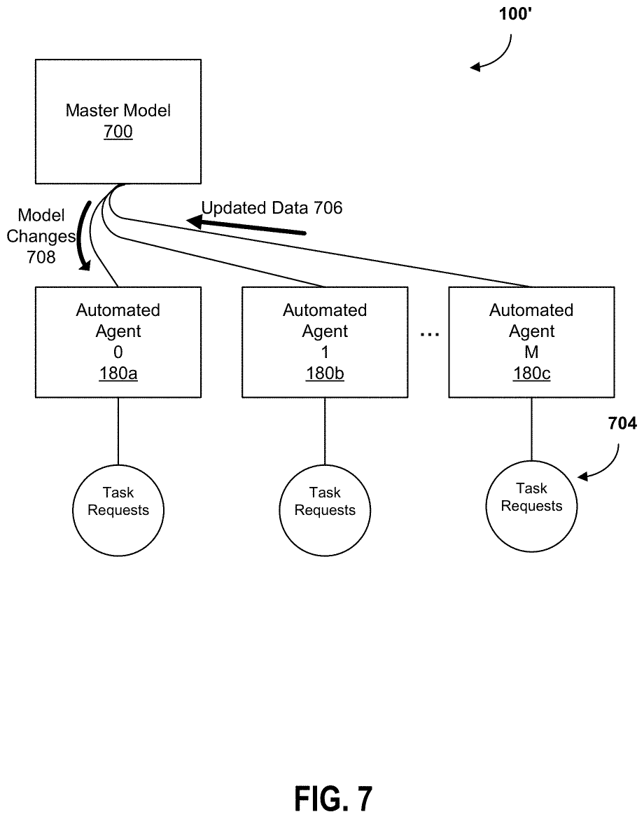

FIG. 7 depicts an embodiment of platform 100′ having a plurality of automated agents 180a, 180b, 180c. In this embodiment, data storage 120 stores a master model 700 that includes data defining a reinforcement learning neural network for instantiating one or more automated agents 180a, 180b, 180c.

During operation, platform 100′ instantiates a plurality of automated agents 180a, 180b, 180c according to master model 700 and each automated agent 180a, 180b, 180c performs operations described herein. For example, each automated agent 180a, 180b, 180c generates tasks requests 704 according to outputs of its reinforcement learning neural network 110.

As the automated agents 180a, 180b, 180c learn during operation, platform 100′ obtains updated data 706 from one or more of the automated agents 180a, 180b, 180c reflective of learnings at the automated agents 180a, 180b, 180c. Updated data 706 includes data descriptive of an “experience” of an automated agent in generating a task request. Updated data 706 may include one or more of: (i) input data to the given automated agent 180a, 180b, 180c and applied normalizations (ii) a list of possible resource task requests evaluated by the given automated agent with associated probabilities of making each requests, and (iii) one or more rewards for generating a task request.

Platform 100′ processes updated data 706 to update master model 700 according to the experience of the automated agent 180a, 180b, 180c providing the updated data 706. Consequently, automated agents 180a, 180b, 180c instantiated thereafter will have benefit of the learnings reflected in updated data 606. Platform 100′ may also sends model changes 708 to the other automated agents 180a, 180b, 180c so that these pre-existing automated agents 180a, 180b, 180c will also have benefit of the learnings reflected in updated data 706. In some embodiments, platform 100′ sends model changes 608 to automated agents 180a, 180b, 180c in quasi-real time, e.g., within a few seconds, or within one second. In one specific embodiment, platform 100′ sends model changes 608 to automated agents 180a, 180b, 180c using a stream-processing platform such as Apache Kafka, provided by the Apache Software Foundation. In some embodiments, platform 100′ processes updated data 706 to optimize expected aggregate reward across based on the experiences of a plurality of automated agents 180a, 180b, 180c.

In some embodiments, platform 100′ obtains updated data 706 after each time step. In other embodiments, platform 100′ obtains updated data 706 after a predefined number of time steps, e.g., 2, 5, 10, etc. In some embodiments, platform 100′ updates master model 700 upon each receipt updated data 706. In other embodiments, platform 100′ updates master model 700 upon reaching a predefined number of receipts of updated data 706, which may all be from one automated agent or from a plurality of automated agents 180a, 180b, 180c.

In one example, platform 100′ instantiates a first automated agent 180a, 180b, 180c and a second automated agent 180a, 180b, 180c, each from master model 700. Platform 100′ obtains updated data 706 from the first automated agents 180a, 180b, 180c. Platform 100′ modifies master model 700 in response to the updated data 706 and then applies a corresponding modification to the second automated agent 180a, 180b, 180c. Of course, the roles of the automated agents 180a, 180b, 180c could be reversed in another example such that platform 100′ obtains updated data 706 from the second automated agent 180a, 180b, 180c and applies a corresponding modification to the first automated agent 180a, 180b, 180c.

In some embodiments of platform 100′, an automated agent may be assigned all tasks for a parent order. In other embodiments, two or more automated agent 700 may cooperatively perform tasks for a parent order; for example, child slices may be distributed across the two or more automated agents 180a, 180b, 180c.

In the depicted embodiment, platform 100′ may include a plurality of I/O units 102, processors 104, communication interfaces 106, and memories 108 distributed across a plurality of computing devices. In some embodiments, each automated agent may be instantiated and/or operated using a subset of the computing devices. In some embodiments, each automated agent may be instantiated and/or operated using a subset of available processors or other compute resources. Conveniently, this allows tasks to be distributed across available compute resources for parallel execution. Other technical advantages include sharing of certain resources, e.g., data storage of the master model, and efficiencies achieved through load balancing. In some embodiments, number of automated agents 180a, 180b, 180c may be adjusted dynamically by platform 100′. Such adjustment may depend, for example, on the number of parent orders to be processed. For example, platform 100′ may instantiate a plurality of automated agents 180a, 180b, 180c in response to receive a large parent order, or a large number of parent orders. In some embodiments, the plurality of automated agents 180a, 180b, 180c may be distributed geographically, e.g., with certain of the automated agent 180a, 180b, 180c placed for geographic proximity to certain trading venues.

In some embodiments, the operation of platform 100′ adheres to a master-worker pattern for parallel processing. In such embodiments, each automated agent 180a, 180b, 180c may function as a “worker” while platform 100′ maintains the “master” by way of master model 700.

Platform 100′ is otherwise substantially similar to platform 100 described herein and each automated agent 180a, 180b, 180c is otherwise substantially similar to automated agent 180 described herein.

Pricing Features: In some embodiments, input normalization may involve the training engine 118 computing pricing features. In some embodiments, pricing features for input normalization may involve price comparison features, passive price features, gap features, and aggressive price features.

Price Comparing Features: In some embodiments, price comparison features can capture the difference between the last (most current) Bid/Ask price and the Bid/Ask price recorded at different time intervals, such as 30 minutes and 60 minutes ago: qt_Bid30, qt_Ask30, qt_Bid60, qt_Ask60. A bid price comparison feature can be normalized by the difference of a quote for a last bid/ask and a quote for a bid/ask at a previous time interval which can be divided by the market average spread. The training engine 118 can “clip” the computed values between a defined ranged or clipping bound, such as between −1 and 1, for example. There can be 30 minute differences computed using clipping bound of −5, 5 and division by 10, for example.

An Ask price comparison feature (or difference) can be computed using an Ask price instead of Bid price. For example, there can be 60-minute differences computed using clipping bound of −10, 10 and division by 10.

Passive Price: The passive price feature can be normalized by dividing a passive price by the market average spread with a clipping bound. The clipping bound can be 0, 1, for example.

Gap: The gap feature can be normalized by dividing a gap price by the market average spread with a clipping bound. The clipping bound can be 0, 1, for example.

Aggressive Price: The aggressive price feature can be normalized by dividing an aggressive price by the market average spread with a clipping bound. The clipping bound can be 0, 1, for example.

Volume and Time Features: In some embodiments, input normalization may involve the training engine 118 computing volume features and time features. In some embodiments, volume features for input normalization involves a total volume of an order, a ratio of volume remaining for order execution, and schedule satisfaction. In some embodiments, the time features for input normalization involves current time of market, a ratio of time remaining for order execution, and a ratio of order duration and trading period length.

Ratio of Order Duration and Trading Period Length: The training engine 118 can compute time features relating to order duration and trading length. The ratio of total order duration and trading period length can be calculated by dividing a total order duration by an approximate trading day or other time period in seconds, minutes, hours, and so on. There may be a clipping bound.

Current Time of the Market: The training engine 118 can compute time features relating to current time of the market. The current time of the market can be normalized by the different between the current market time and the opening time of the day (which can be a default time), which can be divided by an approximate trading day or other time period in seconds, minutes, hours, and so on.

Total Volume of the Order: The training engine 118 can compute volume features relating to the total order volume. The training engine 118 can train the reinforcement learning network 110 using the normalized order count. The total volume of the order can be normalized by dividing the total volume by a scaling factor (which can be a default value).

Ratio of time remaining for order execution: The training engine 118 can compute time features relating to the time remaining for order execution. The ratio of time remaining for order execution can be calculated by dividing the remaining order duration by the total order duration. There may be a clipping bound.

Ratio of volume remaining for order execution: The training engine 118 can compute volume features relating to the remaining order volume. The ratio of volume remaining for order execution can be calculated by dividing the remaining volume by the total volume. There may be a clipping bound.

Schedule Satisfaction: The training engine 118 can compute volume and time features relating to schedule satisfaction features. This can give the model a sense of how much time it has left compared to how much volume it has left. This is an estimate of how much time is left for order execution. A schedule satisfaction feature can be computed the a different of the remaining volume divided by the total volume and the remaining order duration divided by the total order duration. There may be a clipping bound.

VWAPs Features: In some embodiments, input normalization may involve the training engine 118 computing Volume Weighted Average Price features. In some embodiments, Volume Weighted Average Price features for input normalization may involve computing current Volume Weighted Average Price features and quoted Volume Weighted Average Price features.

Current VWAP: Current VWAP can be normalized by the current VWAP adjusted using a clipping bound, such as between −4 and 4 or 0 and 1, for example.

Quote VWAP: Quote VWAP can be normalized by the quoted VWAP adjusted using a clipping bound, such as between −3 and 3 or −1 and 1, for example.

Market Spread Features In some embodiments, input normalization may involve the training engine 118 computing market spread features. In some embodiments, market spread features for input normalization may involve spread averages computed over different time frames.

Several spread averages can be computed over different time frames according to the following equations.

Spread average: Spread average can be the difference between the bid and the ask on the exchange (e.g., on average how large is that gap). This can be the general time range for the duration of the order. The spread average can be normalized by dividing the spread average by the last trade price adjusted using a clipping bound, such as between 0 and 5 or 0 and 1, for example.

Spread σ: Spread a can be the bid and ask value at a specific time step. The spread can be normalized by dividing the spread by the last trade price adjusted using a clipping bound, such as between 0 and 2 or 0 and 1, for example.

Bounds and Bounds Satisfaction In some embodiments, input normalization may involve computing upper bounds, lower bounds, and a bounds satisfaction ratio. The training engine 118 can train the reinforcement learning network 110 using the upper bounds, the lower bounds, and the bounds satisfaction ratio.

Upper Bound: Upper bound can be normalized by multiplying an upper bound value by a scaling factor (such as 10, for example).

Lower Bound: Lower bound can be normalized by multiplying a lower bound value by a scaling factor (such as 10, for example).

Bounds Satisfaction Ratio: Bounds satisfaction ratio can be calculated by a difference between the remaining volume divided by a total volume and remaining order duration divided by a total order duration, and the lower bound can be subtracted from this difference. The result can be divided by the difference between the upper bound and the lower bound. As another example, bounds satisfaction ratio can be calculated by the difference between the schedule satisfaction and the lower bound divided by the difference between the upper bound and the lower bound.

Queue Time: In some embodiments, platform 100 measures the time elapsed between when a resource task (e.g., a trade order) is requested and when the task is completed (e.g., order filled), and such time elapsed may be referred to as a queue time. In some embodiments, platform 100 computes a reward for reinforcement learning neural network 110 that is positively correlated to the time elapsed, so that a greater reward is provided for a greater queue time. Conveniently, in such embodiments, automated agents may be trained to request tasks earlier which may result in higher priority of task completion.

Orders in the Order Book: In some embodiments, input normalization may involve the training engine 118 computing a normalized order count or volume of the order. The count of orders in the order book can be normalized by dividing the number of orders in the order book by the maximum number of orders in the order book (which may be a default value). There may be a clipping bound.

In some embodiments, the platform 100 can configured interface application 130 with different hot keys for triggering control commands which can trigger different operations by platform 100.

One Hot Key for Buy and Sell: In some embodiments, the platform 100 can configured interface application 130 with different hot keys for triggering control commands. An array representing one hot key encoding for Buy and Sell signals can be provided as follows:

Buy: [1, 0]

Sell: [0, 1]

One Hot Key for action: An array representing one hot hey encoding for task actions taken can be provided as follows:

Pass: [1, 0, 0, 0, 0, 0]

Aggressive: [0, 1, 0, 0, 0, 0,]

Top: [0, 0, 1, 0, 0, 0]

Append: [0, 0, 0, 1, 0, 0]

Prepend: [0, 0, 0, 0, 1, 0]

Pop: [0, 0, 0, 0, 0, 1]

In some embodiments, other task actions that can be requested by an automated agent include:

Far touch—go to ask

Near touch—place at bid

Layer in—if there is an order at near touch, order about near touch

Layer out—if there is an order at far touch, order close far touch

Skip—do nothing

Cancel—cancel most aggressive order

In some embodiments, the fill rate for each type of action is measured and data reflective of fill rate is included in task data received at platform 100.

In some embodiments, input normalization may involve the training engine 118 computing a normalized market quote and a normalized market trade. The training engine 118 can train the reinforcement learning network 110 using the normalized market quote and the normalized market trade.

Market Quote: Market quote can be normalized by the market quote adjusted using a clipping bound, such as between −2 and 2 or 0 and 1, for example.

Market Trade: Market trade can be normalized by the market trade adjusted using a clipping bound, such as between −4 and 4 or 0 and 1, for example.

Spam Control: The input data for automated agents 180 may include parameters for a cancel rate and/or an active rate.

Scheduler: In some embodiment, the platform 100 can include a scheduler 116. The scheduler 116 can be configured to follow a historical Volume Weighted Average Price curve to control the reinforcement learning network 110 within schedule satisfaction bounds computed using order volume and order duration. The scheduler 116 can compute schedule satisfaction data to provide the model or reinforcement learning network 110 a sense of how much time it has in comparison to how much volume remains. The schedule satisfaction data is an estimate of how much time is left for the reinforcement learning network 110 to complete the requested order or trade. For example, the scheduler 116 can compute the schedule satisfaction bounds by looking at a different between the remaining volume over the total volume and the remaining order duration over the total order duration.

In some embodiments, automated agents may train on data reflective of trading volume throughout a day, and the generation of resource requests by such automated agents need not be tied to historical volumes. For example, conventionally, some agent upon reaching historical bounds (e.g., indicative of the agent falling behind schedule) may increase aggression to stay within the bounds, or conversely may also increase passivity to stay within bounds, which may result in less optimal trades.

The scheduler 116 can be configured to follow a historical VWAP curve. The difference is that the bounds of the scheduler 116 are fairly high, and the reinforcement learning network 110 takes complete control within the bounds.

The foregoing discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

The embodiments and examples described herein are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

Of course, the above described embodiments are intended to be illustrative only and in no way limiting. The described embodiments are susceptible to many modifications of form, arrangement of parts, details and order of operation. The disclosure is intended to encompass all such modification within its scope, as defined by the claims.

1. A computer-implemented system for automated generation of resource task requests, the system comprising:
a communication interface;
at least one processor;
memory in communication with the at least one processor; and
software code stored in the memory, which when executed at the at least one processor causes the system to:
maintain a reinforcement learning neural network having an output layer with a plurality of policy heads;
provide, to the reinforcement learning neural network, at least one reward corresponding to at least one prior resource task request generated based on outputs of the reinforcement learning neural network;
provide, to the reinforcement learning neural network, state data reflective of a current state of an environment in which resource task requests are made;
obtain a plurality of outputs, each from a corresponding policy head of the plurality of policy heads, the plurality of outputs including a first output defining a quantity of a resource and a second output defining a cost of the resource; and
generate a resource task request signal based on the plurality of outputs from the plurality of policy heads.

2. The computer-implemented system of claim 1, wherein the providing the at least one reward includes providing the at least one reward to each of the plurality of policy heads.

3. The computer-implemented system of claim 1, wherein the at least one reward includes a plurality of rewards, each associated with a corresponding sub-goal of the resource task requests.

4. The computer-implemented system of claim 3, wherein the providing the at least one reward includes providing to each of the plurality of policy heads a subset of the plurality of rewards selected for that policy head.

5. The computer-implemented system of claim 1, wherein the reinforcement learning neural network is maintained in an automated agent.

6. The computer-implemented system of claim 5, wherein the plurality of outputs includes at least one output defining an action to be taken by the automated agent.

7. The computer-implemented system of claim 6, wherein the plurality of outputs includes at least one output defining a parameter of the action.

8. The computer-implemented system of claim 1, wherein the generating includes combining at least two of the plurality of outputs.

9. The computer-implemented system of claim 1, wherein the output layer is interconnected with a plurality of hidden layers of the reinforcement learning neural network.

10. The computer-implemented system of claim 1, wherein the resource task request signal encodes a request to trade a security.

11. The computer-implemented system of claim 10, wherein the plurality of outputs includes at least one output indicating whether the request to trade a security should be made in a lit pool or a dark pool.

12. The computer-implemented system of claim 1, wherein the environment includes a trading venue.

13. A computer-implemented method for automatically generating resource task requests, the method comprising:
maintaining a reinforcement learning neural network having an output layer with a plurality of policy heads;
providing, to the reinforcement learning neural network, at least one reward corresponding to at least one prior resource task request generated based on outputs of the reinforcement learning neural network;
providing, to the reinforcement learning neural network, state data reflective of a current state of an environment in which resource task requests are made;
obtaining a plurality of outputs, each from a corresponding policy head of the plurality of policy heads, the plurality of outputs including a first output defining a quantity of a resource and a second output defining a cost of the resource; and
generating a resource task request signal based on the plurality of outputs from the plurality of policy heads.

14. The computer-implemented method of claim 13, wherein the providing the at least one reward includes providing the at least one reward to each of the plurality of policy heads.

15. The computer-implemented method of claim 13, wherein the at least one reward includes a plurality of rewards, each associated with a corresponding sub-goal of the resource task requests.

16. The computer-implemented method of claim 13, wherein the providing the at least one reward includes providing to each of the plurality of policy head a subset of the plurality of rewards selected for that policy head.

17. A non-transitory computer-readable storage medium storing instructions which when executed adapt at least one computing device to:
maintain a reinforcement learning neural network having an output layer with a plurality of policy heads;
provide at least one reward to the reinforcement learning neural network, the reward corresponding to prior resource task request generated based on the output of the reinforcement learning neural network;
provide state data reflective of a current state of an environment in which resource task requests are made to the reinforcement learning neural network;
obtain a plurality of outputs, each from a corresponding policy head of the plurality of policy heads, the plurality of outputs including a first output defining a quantity of a resource and a second output defining a cost of the resource; and
generate a resource task request signal based on the plurality of outputs from the plurality of policy heads.
